(19) United States
(12) Patent Application Publication
(10) Pub. No.: US 2021/0237507 A1
(43) Pub. Date: Aug. 5, 2021

(54) METHOD OF MANUFACTURING A ROAD WHEEL WITH GALVANIC CORROSION ISOLATION

(71) Applicant: GM GLOBAL TECHNOLOGY OPERATIONS LLC, Detroit, MI (US)

(72) Inventors: Steven J. Schuster, Farmington, MI (US); Ming Liu, Shanghai (CN); Jianfeng Wang, Nanjing (CN)

(73) Assignee: GM GLOBAL TECHNOLOGY OPERATIONS LLC, Detroit, MI (US)

(21) Appl. No.: 16/780,303

(22) Filed: Feb. 3, 2020

(51) Int. Cl. B60B 3/00; B60B 3/12

(52) U.S. Cl. CPC B60B 3/008; B60B 2340/50; B60B 3/12

(57) ABSTRACT

A method of assembling a vehicle road wheel includes providing a tool fixture configured to support a press-fit load and arranging on the tool fixture an isolation plate defining a plate fastener aperture and having a locating projection. The method additionally includes arranging on the isolation plate a wheel subassembly having a hub surface and an opposing fastener surface and defining a hub aperture and a wheel fastener aperture, such that the hub surface rests against the isolation plate. The method also includes aligning the hub aperture with the locating projection and the wheel fastener aperture with the plate fastener aperture. The method additionally includes installing an insert into the wheel fastener aperture and engaging the insert with the plate fastener aperture. Furthermore, the method includes applying a load to the insert to press-fit the insert into the isolation plate at the plate fastener aperture and thereby assemble the wheel.

### INTRODUCTION

The present disclosure relates to a method of manufacturing a road wheel with galvanic corrosion isolation for use on a motor vehicle.

Road-going motor vehicles typically use wheels with inflatable tires mounted thereon as vehicles' interface with various terrain, ranging from paved highways to rocky trails. Such wheel and tire assemblies are typically mounted via fasteners to vehicle suspension components, such as wheel hubs (connected via springs to the vehicle body) Wheels may be constructed from various metals, for example, steel, aluminum, or magnesium.

Fastened assemblies using metal components may experience corrosion when exposed to the elements. Specifically, fastened assemblies using magnesium components may experience galvanic corrosion. Galvanic corrosion is an electrochemical process in which one metal corrodes preferentially when in contact with a different type of metal, and both metals are immersed in an electrolyte. In the event moisture is trapped inside an assembly having a magnesium component, such as a magnesium wheel fastened to an iron wheel hub with steel fastener(s), the trapped moisture may provide such an electrolyte.

### SUMMARY

A method of assembling a road wheel for a motor vehicle includes providing a tool fixture configured to support a press-fit load. The method also includes arranging on the tool fixture an isolation plate defining a plate fastener aperture and having a locating projection. The method additionally includes arranging on the isolation plate a wheel subassembly having a hub surface and an opposing fastener surface, and defining a hub aperture and a wheel fastener aperture, such that the hub surface rests against the isolation plate. The method also includes aligning the hub aperture with the locating projection and the wheel fastener aperture with the plate fastener aperture. The method additionally includes installing a fastener seat insert into the wheel fastener aperture and engaging the fastener seat insert with the plate fastener aperture. Furthermore, the method includes applying a load to the fastener seat insert to press-fit the fastener seat insert into the isolation plate at the plate fastener aperture and thereby assemble the road wheel.

The tool fixture may be defined by a convex surface. The method may additionally include centering the locating projection of the isolation plate on the convex surface prior to arranging the wheel subassembly on the isolation plate.

The isolation plate may be constructed from aluminum.

The fastener seat insert may be constructed from aluminum.

The wheel subassembly may be constructed from magnesium.

The wheel fastener aperture may, at least in part, be defined by a conical shape. The conical shape may diverge toward the fastener surface.

The fastener seat insert may have a conical shape section and a cylindrical shape section. The conical shape section may be configured to match the conical shape of the wheel fastener aperture.

The cylindrical shape section may be defined by an inner diameter and an outer diameter with respect to an axis. The cylindrical shape section may include serrations arranged on the outer diameter and oriented along the axis.

The applied load may be equal to or greater than 50 kN.

The load may be applied to the fastener seat insert via a punch having a punch head defined by a conical shape configured to match the conical shape of the wheel fastener aperture.

The above-disclosed method of wheel assembly provides the wheel, especially a wheel constructed from magnesium, with galvanic corrosion isolation in the hub area.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of a motor vehicle employing a plurality of road wheels with galvanic corrosion isolation, according to the disclosure.

FIG. 2 is a schematic perspective exploded view of a vehicle suspension corner supporting the road wheel shown in FIG. 1, wherein the road wheel includes a wheel subassembly, isolation plate, fastener seat inserts, and fasteners, according to the disclosure.

FIG. 3 is a schematic close-up partial cross-sectional view of the isolation plate and fastener seat inserts in position before being pressed together around the wheel subassembly, according to the disclosure

FIG. 4 is a schematic close-up cross-sectional view of an embodiment of the fastener seat insert, according to the disclosure.

FIG. 5 is a schematic close-up partial cross-sectional view of the isolation plate and fastener seat inserts being pressed together around the wheel subassembly, according to the disclosure.

FIG. 6 is a schematic depiction of tooling employed for assembly of the isolation plate and fastener seat inserts with the wheel subassembly shown in FIGS. 2-5, according to the disclosure.

FIG. 7 illustrates a method of assembling the road wheel with galvanic corrosion isolation shown in FIGS. 1-6.

### DETAILED DESCRIPTION

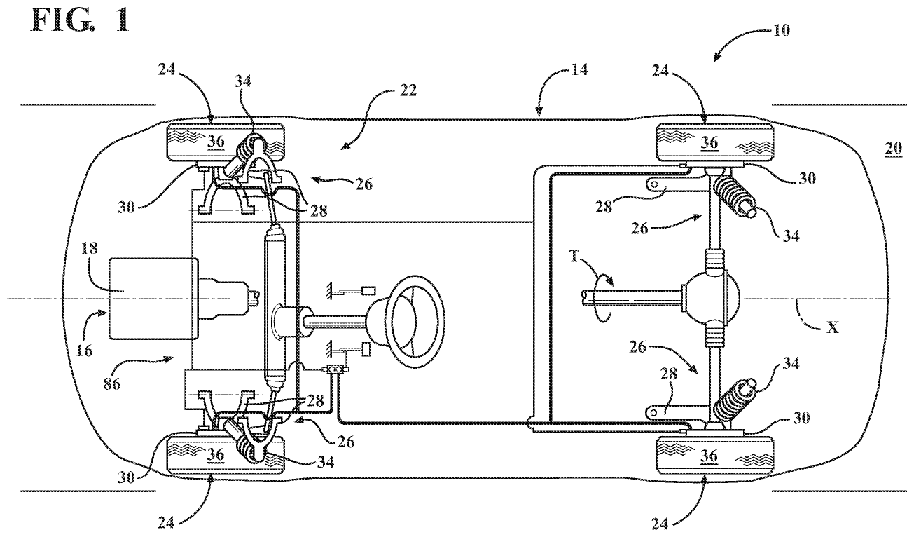

Referring to FIG. 1, a motor vehicle 10 arranged along a vehicle central axis X is depicted. The vehicle 10 may be a mobile platform, such as a passenger vehicle, an all-terrain vehicle (ATV), an airplane, etc., used for personal, commercial, or industrial purpose. As shown, the vehicle 10 includes a vehicle body 14 and a powertrain 16. The powertrain 16 includes a power-source 18 configured to generate a power-source torque T for propulsion of the vehicle 10 along a road surface 20.

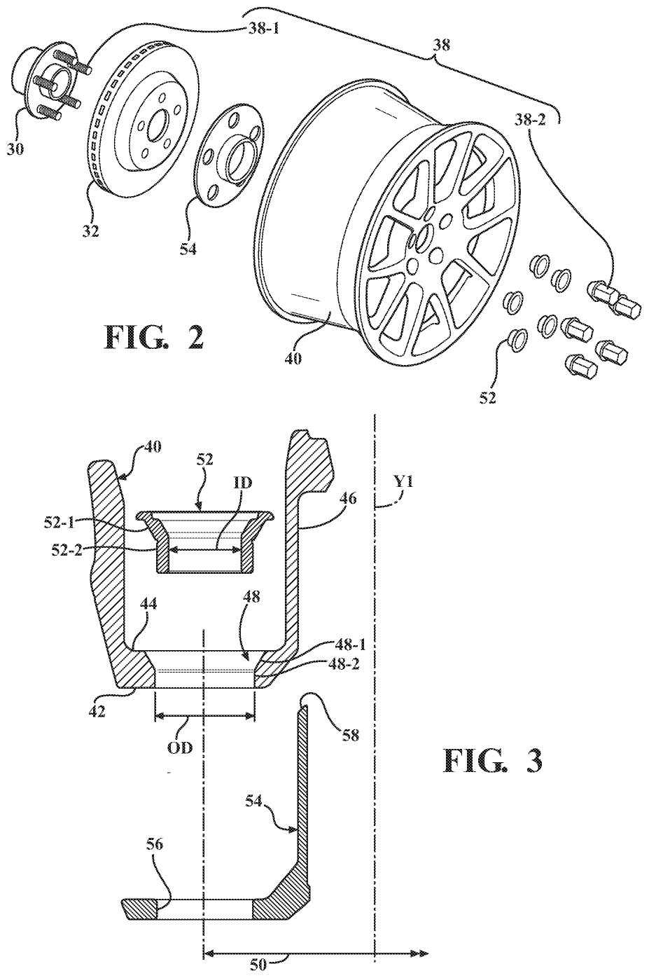

As also shown in FIG. 1, a vehicle suspension system 22 operatively connects the body 14 to respective road wheels 24 for maintaining contact between the vehicle 10 and the road surface 20, and maintaining handling of the vehicle. Specific corners 26, which may include control arm(s) 28, a wheel hub 30, a brake rotor 32 (shown in FIG. 2), and a strut 34, of the suspension system 22 are shown. Suspension corner designs distinct from the suspension corners 26 shown in FIG. 1, are also envisioned. As shown, each corner 26 of the suspension system 22 is connected to a respective road wheel 24. The road wheel 24 may be a driven wheel configured to receive the power-source torque T, or be non-driven. Although not shown, the vehicle 10 may also include a spare wheel 24. Each road wheel 24 is configured to mount a pneumatic or non-pneumatic tire 36 thereon for contact with the road surface 20.

Each road wheel 24 is attached to the suspension system 22, such as to the wheel hub 30, via a plurality of fasteners 38. The fasteners 38 may include studs 38-1 mounted to the wheel hub 30 and steel nuts 38-2 (shown in FIG. 2), or steel bolts (not shown). Each of the wheels 24 may be constructed, such as forged or cast and then machined, from a magnesium-based alloy. Magnesium may be selected as the base material for the wheels 24 for its advantageous strength to mass ratio. For example, magnesium has two-thirds the density of aluminum. In moisture-rich environments, however, magnesium may be susceptible to corrosion. Specifically, when two or more different types of metal, such as magnesium and iron, come into contact in the presence of an electrolyte, a galvanic couple may be generated due to different electrode potentials of the different metals.

The electrolyte provides a means for ion migration, whereby metallic ions can move from the anode to the cathode of the galvanic couple. Such a process typically leads to the anodic metal corroding more quickly than it would otherwise, while the corrosion of the cathodic metal is retarded, even to the point of stopping. The presence of electrolyte and a conducting path between the different metal components may cause corrosion where otherwise neither metal component alone would have corroded. Even a single type of metal may corrode galvanically, if the electrolyte varies in composition, thus forming a concentration cell. Accordingly, design of the fastening system and selection of the component materials in the assembly with an eye toward reducing galvanic corrosion may prove critical to the reliability of the subject assembly.

In general, when the vehicle 10 is exposed to the elements, moisture may penetrate the interface between, wheel hub and brake rotor (each typically constructed from iron), the fasteners, and a magnesium road wheel. Upon penetration of the interface, the moisture is likely to become trapped and remain inside the assembly. Consequently, such moisture may form an electrolyte that may then lead to galvanic corrosion between the magnesium road wheel, the iron wheel hub, and the steel fasteners. Crevice-type of galvanic corrosion is especially likely to develop if a protective surface of any of the magnesium road wheel, the iron wheel hub, and the steel fasteners develops a scratch, thus exposing areas of bare metal. Additionally, protective chemically nonreactive coatings for the iron wheel hub and the steel fasteners create a more stable situation when moisture is trapped inside the assembly, which may otherwise form a corrosive electrolyte.

As shown in FIGS. 2-6, the wheel 24 is an assembly constructed from multiple components, specifically to break a conducting path between the different metal components, and thereby minimize the incidence of galvanic corrosion when the wheel is exposed to moisture. The wheel 24 includes a wheel subassembly 40 arranged relative to a central axis Y1. The wheel subassembly 40 has a hub surface 42 and an opposing fastener surface 44. The wheel subassembly 40 defines a centrally located hub aperture 46, i.e., concentric with the central axis Y1. The wheel subassembly 40 further defines a plurality of wheel fastener apertures 48 arranged on a pitch circle 50 centered on the central axis Y1. Each wheel fastener aperture 48 is configured to accept one of the plurality of fasteners 38 for mounting the wheel 24 to the wheel hub 30 and retaining the brake rotor 32 therebetween.

Additionally, as shown in FIGS. 3 and 5, each wheel fastener aperture 48 may be at least in part defined by a conical shape section 48-1, with the conical shape diverging toward the fastener surface 44. As shown in FIGS. 3 and 5, each wheel fastener aperture 48 may also be defined by a substantially cylindrically shaped section 48-2. Alternatively, although not shown, each wheel fastener aperture 48 may be at least in part defined by a spherically shaped section opening up toward the fastener surface 44 and also include a substantially cylindrically shaped section (similar to section 48-2), or the entire aperture 48 may have a substantially cylindrically shape extending from a generally flat fastener surface 44.

As shown in FIGS. 2-5, the wheel 24 also includes a plurality of fastener seat inserts 52. The number of fastener seat inserts 52 matches the number of wheel fastener apertures 48, and each seat insert is installed into a respective fastener aperture. Each fastener seat insert 52 may be constructed from a more noble/less anodic material, such as aluminum to reduce electrode potential difference between individual components of the final wheel assembly 24. The fastener seat inserts have a shape generally conceived to match the chosen shape of the respective wheel fastener apertures 48. As shown in FIGS. 3 and 5, each fastener seat insert 52 may have a conical shape section 52-1 and a cylindrical shape section 52-2. Such a conical shape section 52-1 is configured to match the conical shape section 48-1 embodiment of the wheel fastener aperture shown in FIGS. 3 and 5. In the event the wheel fastener apertures 48 include the spherically shaped sections or flat fastener surfaces as described above, the shape of the fastener seat inserts 52 would be configured to match the corresponding shape of the wheel fastener apertures. As shown, the cylindrical shape section 52-2 is defined by an inner diameter ID and an outer diameter OD with respect to a fastener axis Y2.

The wheel 24 additionally includes an isolation plate 54 defining a plurality of plate fastener apertures 56 and having a centrally arranged, i.e., concentric with the central axis Y1, locating projection 58. The isolation plate 54, including the locating projection 58, may be constructed from a more noble/less anodic material, such as an aluminum alloy, configured to disconnect and isolate the wheel subassembly 40 from the brake rotor 32. As shown, the number of plate fastener apertures 56 matches the number of wheel fastener apertures 48, and, therefore, the number of fastener seat inserts 52. The fastener seat inserts 52 are arranged on the fastener surface 44, while the isolation plate 54 is arranged on the hub surface 42. During assembly of the wheel 24, the locating projection 58 is engaged with the hub aperture 46. Specifically, the locating projection 58 may be engaged with the hub aperture 46 (shown in FIG. 5) via a snug fit therebetween or a light press fit.

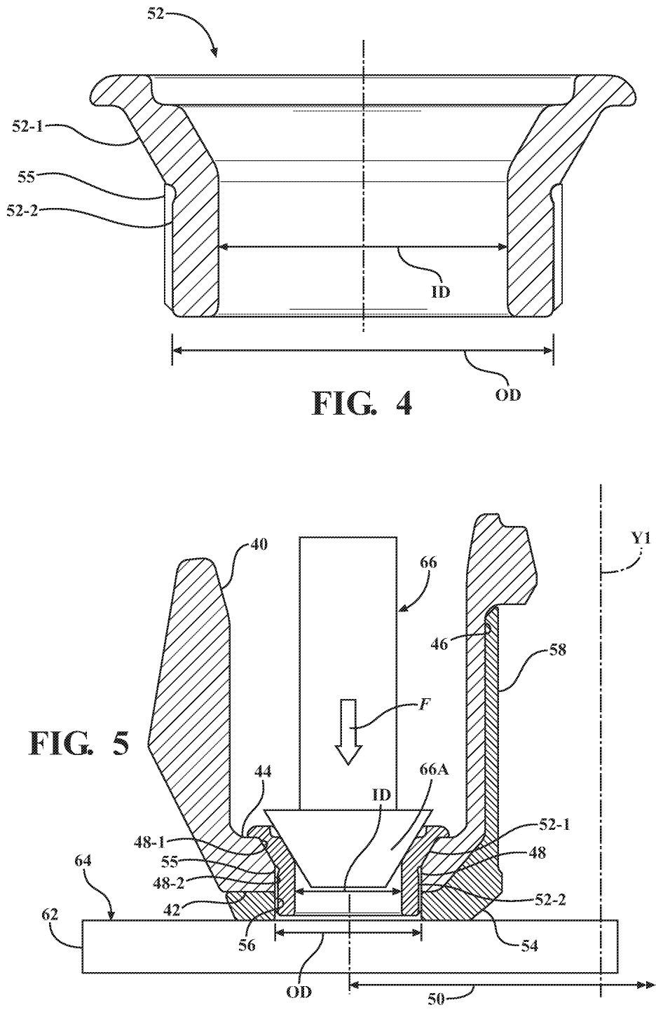

The fastener seat inserts 52 may include protrusions or serrations 55 (shown in FIG. 4) arranged on the cylindrical shape section 52-2 for engagement and interference fit with each of the plate fastener apertures 56 and the isolation plate 54. A snug fit or a light press fit of the serrations 55 with the cylindrically shaped section 48-2 of the wheel fastener aperture 48 is used for centering. The plate fastener aperture 56 of the isolation plate 54 facilitates retention of the fastener seat insert 52 within the isolation plate 54. Additionally, the press fit of the serrations 55 with the plate fastener aperture 56 of the isolation plate 54 facilitates retention of the fastener seat insert 52 within the wheel fastener aperture 48. To ensure the fit of the particular fastener seat insert 52 with each of the cylindrically shaped section 48-2 and the plate fastener aperture 56, the serrations 55 may extend substantially the entire length of the cylindrical shape section 52-2. The serrations 55 may be arranged on the outer diameter OD and oriented along the fastener axis Y2. Alternatively, the serrations 55 may be arranged on the outer diameter OD but oriented at a non-zero, such as a generally acute angle with respect to the fastener axis Y2 (not shown). Each fastener seat insert 52 may be constructed from a chemically nonreactive material, such as an aluminum alloy.

The fastener seat inserts 52 are press-fit into the plate fastener apertures 56, thereby sandwiching the magnesium wheel subassembly 40 between the seat inserts and the isolation plate 54. Thus, sandwiching the magnesium wheel subassembly 40 between two nonreactive components severs an electrochemical path for a reaction between the magnesium wheel subassembly and the combination of an iron wheel hub 30 and brake rotor 32, and thereby reduces possibility of galvanic corrosion. Accordingly, sandwiching the magnesium wheel subassembly 40 between two more noble/less anodic components reduces electrode potential between the magnesium wheel subassembly and the iron wheel hub 30 and iron or steel fasteners 38, and thereby reduces possibility of galvanic corrosion. Additionally, selection of appropriate alloys of aluminum for the fastener seat insert 52 and the isolation plate 54 will further limit the seat insert and the isolation plate from exhibiting galvanic corrosion.

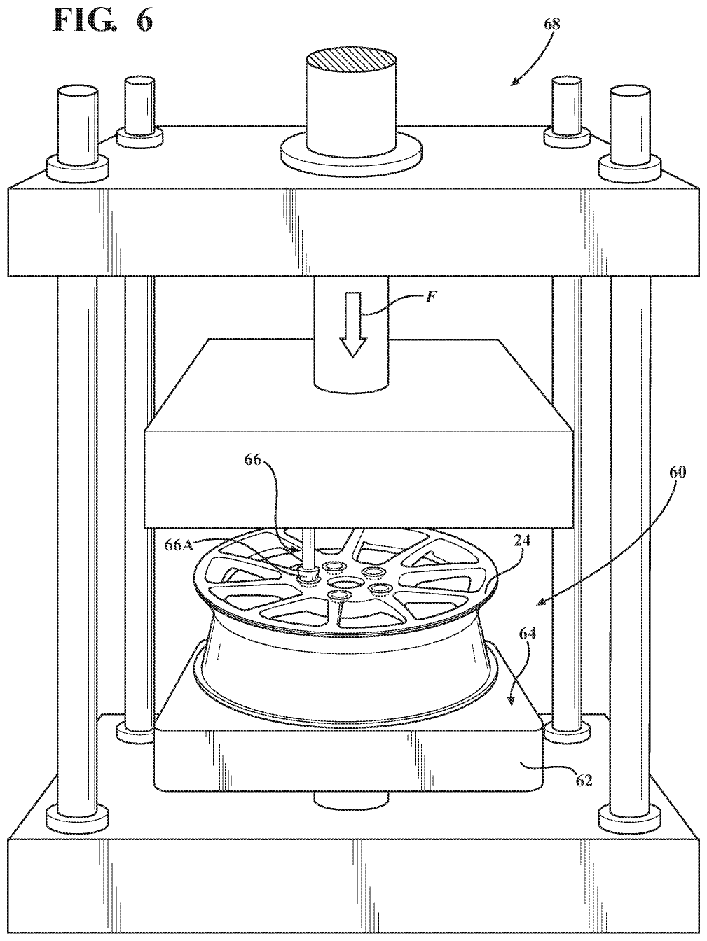

The road wheel 24 may be assembled using assembly tooling 60 shown in FIG. 6. The assembly tooling 60 includes a tool fixture 62. The tool fixture 62 is configured to support a press-fit load or force F (shown in FIGS. 5 and 6) sufficient to assemble the road wheel 24. As shown, the tool fixture 62 may be defined by a convex surface 64. The convex surface 64 may be used to center the locating projection 58 of the isolation plate 54 thereon prior to arranging and centering the wheel subassembly 40 on the isolation plate 54. Alternatively, the surface 64 may be flat. The assembly tooling 60 also includes one or more punches 66. As shown, each punch 66 has a punch head 66A (shown in FIGS. 5 and 6) defined by a shape configured to substantially match the corresponding contacting surfaces of the steel nut 38-2 and the conical shape section 52-1 of the fastener seat insert 52. Additionally, the shape of the punch head 66A may be configured to substantially match the conical shape section 48-1 of the corresponding wheel fastener aperture 48. Accordingly, the punch head 66A may have a conical, substantially spherical, or a flat shape. FIGS. 5 and 6 specifically depict the conical shape of the punch head 66A configured to match the wheel assembly embodiment having the aperture conical shape 48-1 and the conical shape section 52-1 of the fastener seat insert 52.

As shown in FIG. 6, the punch 66 may be engaged by a machine press 68, which is configured to exert the force F to each of the fastener seat inserts 52, either to all inserts simultaneously or to each individually, to thereby press-fit the fastener seat inserts into the plate fastener apertures 56. The applied force F may be equal to or greater than 50 kN. Thus pressed together, the more noble/less anodic fastener seat inserts 52 and the isolation plate 54 sandwich the magnesium wheel subassembly 40 to minimize incidence of galvanic corrosion in the final assembly of the wheel 24. Such construction of the wheel 24 is further intended to limit incidence of galvanic corrosion of the wheel's individual components when the wheel 24 abuts the iron rotor 32 and is fastened via steel fasteners 38 to the iron wheel hub 30 on the vehicle 10.

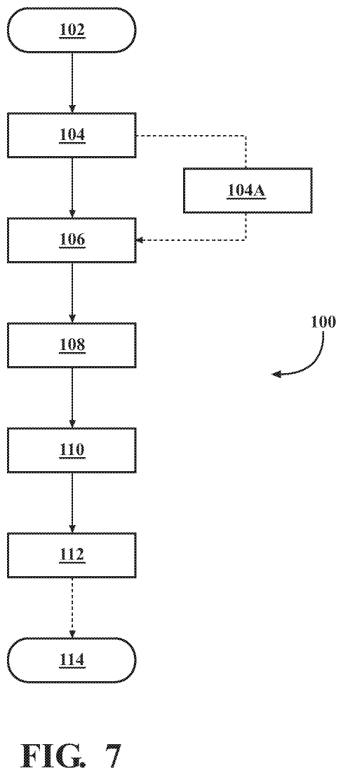

A method 100, shown in FIG. 7, may be used to assemble the road wheel 24. The method 100 is described below with reference to the structure of the wheel 24, shown in FIGS. 2-5, and the assembly tooling 60 shown in FIG. 6. Method 100 commences in frame 102 with providing the tool fixture 62. Following frame 102, the method advances to frame 104. In frame 104, the method includes arranging the isolation plate 54 on the tool fixture 62. After frame 104 the method may initially proceed to frame 104A, where the method includes centering the isolation plate 54, such as at the locating projection 58, on the convex surface 64.

If the method includes centering the isolation plate 54 on the convex surface 64, following frame 104A, the method would advance to frame 106. Otherwise, the method moves on to frame 106 directly from frame 104. In frame 106, the method includes arranging the wheel subassembly 40 on the isolation plate 54, such that the hub surface 42 rests against the isolation plate. After frame 106 the method proceeds to frame 108, where the method includes aligning the hub aperture 46 with the locating projection 58 and the wheel fastener apertures 48 with the plate fastener aperture 56. Following frame 108, the method proceeds to frame 110.

In frame 110 the method includes installing, such as inserting from the side of the fastener surface 44, the fastener seat inserts 52 into the wheel fastener aperture 48. In frame 110, the method also includes engaging the fastener seat inserts 52 with the isolation plate 54 at the corresponding plate fastener apertures 56. After frame 110 the method proceeds to frame 112, where the method includes applying the load F to the fastener seat inserts 52 to press-fit the fastener seat inserts into the isolation plate 54 at the plate fastener apertures 56. Once the fastener seat inserts 52 have been press-fit into the isolation plate 54, assembly of the road wheel 24 with galvanic corrosion isolation may be complete, and the method may conclude in frame 114.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A method of assembling a road wheel for a motor vehicle, the method comprising:
arranging, on a tool fixture, an isolation plate defining a plate fastener aperture and having a locating projection;
arranging on the isolation plate a wheel subassembly having a hub surface and an opposing fastener surface and defining a hub aperture and a wheel fastener aperture, such that the hub surface rests against the isolation plate;
aligning the hub aperture with the locating projection and the wheel fastener aperture with the plate fastener aperture;
installing a fastener seat insert into the wheel fastener aperture and engaging the fastener seat insert with the plate fastener aperture; and
applying a load to the fastener seat insert to press-fit the fastener seat insert into the isolation plate at the plate fastener aperture and thereby assemble the road wheel.

2. The method of claim 1, wherein the tool fixture is defined by a convex surface, the method further comprising centering the locating projection on the convex surface prior to arranging the wheel subassembly on the isolation plate.

3. The method of claim 1, wherein the isolation plate is constructed from aluminum.

4. The method of claim 1, wherein the fastener seat insert is constructed from aluminum.

5. The method of claim 1, wherein the wheel subassembly is constructed from magnesium.

6. The method of claim 1, wherein the wheel fastener aperture is at least in part defined by a conical shape, with the conical shape diverging toward the fastener surface.

7. The method of claim 6, wherein the fastener seat insert has a conical shape section and a cylindrical shape section, and wherein the conical shape section is configured to match the conical shape of the wheel fastener aperture.

8. The method of claim 7, wherein the cylindrical shape section is defined by an inner diameter and an outer diameter with respect to an axis, and wherein the cylindrical shape section includes serrations arranged on the outer diameter and oriented along the axis.

9. The method of claim 1, wherein the applied load is equal to or greater than 50 kN.

10. The method of claim 1, wherein applying the load to the fastener seat insert is via a punch having a punch head defined by a conical shape configured to match the conical shape of the wheel fastener aperture.

11. A method of assembling a magnesium road wheel with galvanic corrosion isolation for a motor vehicle, the method comprising:
arranging, on a tool fixture, an aluminum isolation plate defining a plate fastener aperture and having a locating projection;
arranging on the aluminum isolation plate a magnesium wheel subassembly having a hub surface and an opposing fastener surface and defining a hub aperture and a wheel fastener aperture, such that the hub surface rests against the aluminum isolation plate;
aligning the hub aperture with the locating projection and the wheel fastener aperture with the plate fastener aperture;
installing an aluminum fastener seat insert into the wheel fastener aperture and engaging the aluminum fastener seat insert with the plate fastener aperture; and
applying a load to the aluminum fastener seat insert to press-fit the aluminum fastener seat insert into the isolation plate at the plate fastener aperture and thereby assemble the magnesium road wheel.

12. The method of claim 11, wherein the tool fixture is defined by a convex surface, the method further comprising centering the locating projection on the convex surface prior to arranging the wheel subassembly on the isolation plate.

13. The method of claim 11, wherein the wheel fastener aperture is at least in part defined by a conical shape, with the conical shape diverging toward the fastener surface.

14. The method of claim 13, wherein the fastener seat insert has a conical shape section and a cylindrical shape section, and wherein the conical shape section is configured to match the conical shape of the wheel fastener aperture.

15. The method of claim 14, wherein the cylindrical shape section is defined by an inner diameter and an outer diameter with respect to an axis, and wherein the cylindrical shape section includes serrations arranged on the outer diameter and oriented along the axis.

16. The method of claim 11, wherein the applied load is equal to or greater than 50 kN.

17. The method of claim 11, wherein applying the load to the fastener seat insert is via a punch having a punch head defined by a conical shape configured to match the conical shape of the wheel fastener aperture.

18. A method of assembling a road wheel for a motor vehicle, the method comprising:
arranging, on a tool fixture defined by a convex surface, an isolation plate defining a plate fastener aperture and having a locating projection;
centering the locating projection on the convex surface of the tool fixture;
arranging on the isolation plate a wheel subassembly having a hub surface and an opposing fastener surface and defining a hub aperture and a wheel fastener aperture, such that the hub surface rests against the isolation plate;
aligning the hub aperture with the locating projection and the wheel fastener aperture with the plate fastener aperture;
installing a fastener seat insert into the wheel fastener aperture and engaging the fastener seat insert with the plate fastener aperture; and
applying a load to the fastener seat insert to press-fit the fastener seat insert into the isolation plate at the plate fastener aperture and thereby assemble the road wheel.

19. The method of claim 18, wherein:
the wheel fastener aperture is at least in part defined by a conical shape, with the conical shape diverging toward the fastener surface;
the fastener seat insert has a conical shape section and a cylindrical shape section, and wherein the conical shape section is configured to match the conical shape of the wheel fastener aperture; and
the cylindrical shape section is defined by an inner diameter and an outer diameter with respect to an axis, and wherein the cylindrical shape section includes serrations arranged on the outer diameter and oriented along the axis.

20. The method of claim 18, wherein the applied load is equal to or greater than 50 kN.
